(19) United States
(12) Patent Application Publication
(10) Pub. No.: US 2004/0104550 A1
(43) Pub. Date: Jun. 3, 2004

(54) Scuba tank boot

(76) Inventor: Tai Do, San Jose, CA (US)

Correspondence Address: SCHNECK & SCHNECK, P.O. BOX 2-E, SAN JOSE, CA, 95109-0005, US

(21) Appl. No.: 10/309,610

(22) Filed: Dec. 3, 2002

(51) Int. Cl. B62B 1/26

(52) U.S. Cl. 280/47.26; 280/79.5

(57) ABSTRACT

A scuba tank boot having an integrated wheel at the bottom of the boot to allow the tank to be rolled over a surface when the tank is angled. The boot includes a feature to retain the boot on the scuba tank.

### TECHNICAL FIELD

The invention relates to scuba tank devices and more specifically to protective covers for the bottoms of scuba tanks.

### BACKGROUND OF THE INVENTION

Scuba diving has become an increasingly popular recreational activity. Diving requires a substantial amount of equipment. Each diver must have an air tank, a buoyancy control device, a regulator, weights (to control buoyancy), fins, a mask, a snorkel and commonly also a wet suit. Optional equipment may include video or still cameras, spear guns, lights, dive computers or other equipment. This equipment must be transferred from an automobile to either a beach dive site or across a dock to a boat.

This equipment can be quite heavy, especially the large compressed air tanks. Following a first dive, empty tanks may be stowed and replaced with full tanks to allow for additional diving time. If a diver has driven to a shore entry dive spot, the diver then must return to a vehicle with an empty tank, exchange tanks, and return to the dive spot.

Moving tanks can be quite tiring. Many dive spots have optimal entry points that may be a significant distance away from parking locations. An initial dive requires transport of all gear to an entry location. Later dives require return to a vehicle and exchanging empty tanks for filled tanks. For a boat dive, the equipment must be transported from a car or van across a dock to a boat.

Because dive equipment is expensive a number of different devices are in use to protect the bottom of cylindrical scuba diving air tanks. In addition to protecting the bottom of the tank, these devices also aid in stabilizing the tank on a flat surface. This is advantageous when transporting a tank in a vehicle or storing the tank in a shop or garage.

U.S. Pat. No. 3,809,353 discloses a boot for the attachment to the bottom of a scuba tank. Ribbed sides of the interior side walls of the boot retain the boot on the tank. The friction fit is sufficient that the boot is retained on the tank during diving. The bottom of the boot has a number of arms to prevent the boot from moving beyond the bottom of the tank.

U.S. Pat. No. 3,929,312 discloses an alternate boot for a scuba tank. This boot also has ribbed side walls of the interior boot body that frictionally retain the boot while diving. The bottom of the boot body is an annular lip extending toward the longitudinal center of the boot. The tank rests on a series of projections that extend from the side to the center-most edge of the boot bottom. This allows water to flow through the ribs and along the lip. Water may readily drain away from the tank when the tank is not submerged.

These boots address the need to protect the bottom of the tank. However, these references do not provide a solution for the transport of the tank.

A number of carts have been designed to transport scuba tanks. For example, U.S. Pat. No. 5,393,080 discloses a scuba tank dolly that includes a frame for retention of a scuba tank and base having wheels to transport the tank. U.S. Pat. No. 5,131,670 discloses a tank cart comprised of a wire frame holding an axle. Two wheels mounted on the axle allow transport of the cart.

Because leaving the tank cart on at the entry point of a dive would risk loss, the cart must be returned to the vehicle prior to the dive. This would generally require an extra trip to the vehicle before the initial dive. For subsequent dives two extra trips are required, a first to retrieve the cart to transport an empty tank and a second to return the cart after a full tank is retrieved from the vehicle. These extra trips can be tiresome, expending energy that could be needed for the dives. In additional the carts do not protect or stabilize the bottom of the scuba tank.

It is an object of the invention to provide a dive boot that has an integrated means for transport of a tank. This boot should be inexpensive to manufacture, durable, and relatively light weight.

### SUMMARY OF THE INVENTION

The above objects have been achieved with a dive boot having a pair of wheels extending from a back section of the boot. The wheels are positioned such that the wheels engage with the ground when the tank is moved at an angle. These wheels may be mounted on mounts extending from the back of the boot, with each mount having an axle on which one wheel is mounted.

The boot has a body having interior ribs or other means for retaining the boot onto the side of the tank. The bottom of the boot is an annular lip. This lip may have holes or raised sections on the lip to allow for liquid passing along the sides of the boot between the boot body and the tank to move past the boot body.

### BRIEF DESCRIPTION OF THE DRAWINGS

FIG. 1 is a side view of a scuba tank having a tank boot with wheels mounted on the tank.

FIG. 2 is a top view of the scuba tank boot.

FIG. 3 is a perspective view of the scuba tank boot.

### DETAILED DESCRIPTION OF THE INVENTION

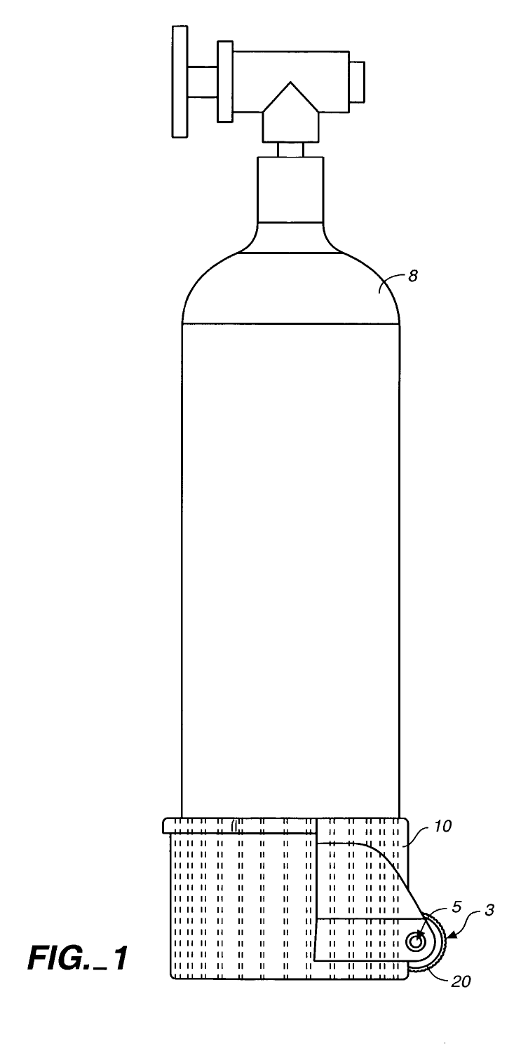

With respect to FIG. 1, a scuba tank 8 is shown having boot body 10 attached to the bottom of tank 8. Wheel 20 is affixed to boot body 10. Boot body 10 and wheel 20 are made of a resilient plastic material that does not react or degrade when repeatedly exposed to salt water. When tank 8 is angled, wheel 20 will make contact with the ground, allowing the tank to be rolled over a surface. When tipped upright, tank 8 rests on the bottom of boot body 10. This gives the tank stability when the tank is resting on a flat surface.

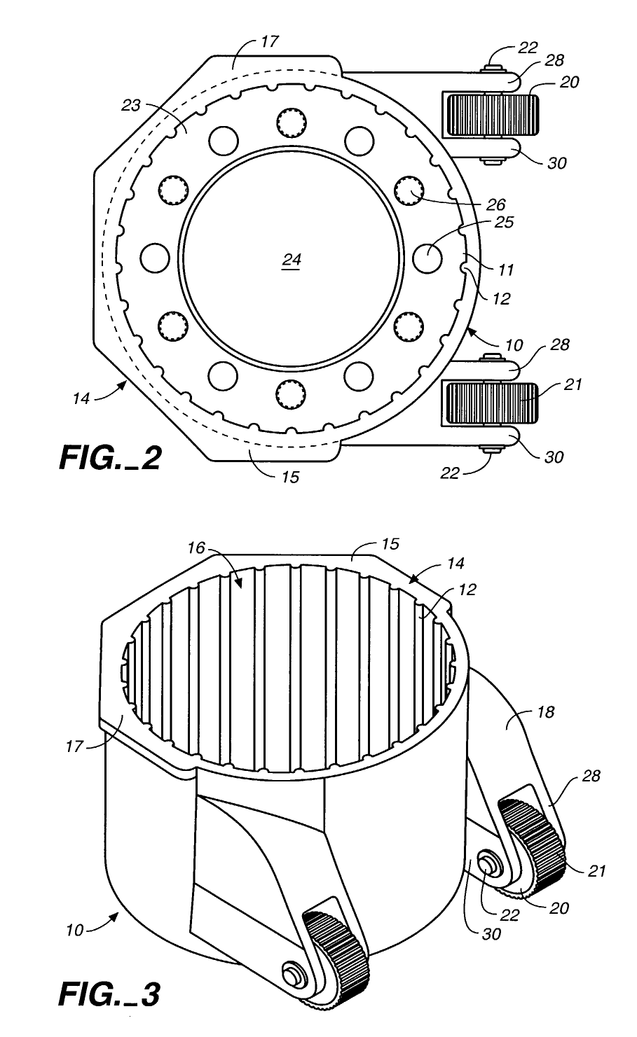

With reference to FIGS. 2 and 3, the boot body 10 has an annular flange 14 extending from the top lip of the boot body away from the center of the boot body and an annular lip 23 at the bottom of the boot body extending toward the interior center of the boot body 10.

Annular flange 14 should be relatively thin (1 cm or less). Flange 14 extends about three quarters of the circumference of the top rim of the boot body along two sides and the front of the rim. The shape of flange 14 includes a number of facets. In the example shown, each facet of flange 14 extends for 45 degrees of the circumference of the rim of boot body 10. However, fewer or greater number of facets may be used. Side facets 15, 17 are on either side of boot body 10. If transporting the tank in a car, the facets allow the tank to be placed on its side without rolling. This can prevent damage to the tank, which may occur if the tank rolls across a surface. In addition, when tanks are stood upright and positioned side to side, the side facets provide a flat surface that can be pressed against another flat side facet to give a row of tanks (as would be lined up on a dive boat or in a shop) added stability. This would be much greater stability than that afforded by cylindrical air tanks in contact at one side location.

The exterior surface of boot body 10 is a flat smooth surface. The interior side walls 16 of boot body 10 contain ribs 12 which extend from the top to the bottom of boot body 10. In FIG. 2, at the base of rib 12 is hole 11. A compressed air tank is inserted into boot body 10, the ribs deform sufficiently to allow the boot to be fit onto the tank. Ribs 12 fit against the tank with sufficient frictional force to retain boot 10 in its position on the tank during dives. Holes 11 allow water to drain from the bottom of the tank, allowing the boot to be washed and drained without retaining water that could grow mildew.

At the bottom of boot body 10 is an annular lip 23. Annular lip extends from the bottom of the side walls of boot body 10. Preferably, lip 23 defined a central hole 24 from which water may escape. On lip 23 additional holes 25 allow water to drain. Raised pads 26 on lip 23 act as a stop to limit how far a tank may be inserted into boot body 10. Water may then drain away from the bottom of the scuba tank, which does not rest on the bottom of the boot.

Struts 28, 30 extend from the sides of boot body 10. A wheel 20 is positioned between struts 28, 30 on an axle 22. The treads 21 on wheel 20 allow for rolling over rough surfaces and sand. In FIG. 3, a bridge 18 extends between the struts, providing some protection of wheels 20 and reducing the risk that something could get caught between wheels 20 and boot body 10.

A number of different variations to the present design are available. In the foregoing illustrations the boot was secured to the tank by ribs. It is also possible to use straps, a circular cinching clamp, magnets, a receiving fitting or other means to secure the boot to the tank. In addition, the boot body could taper, to allow the boot to be frictionally fit onto the boot.

The boot may be made of a number of different materials, as long as the material did not react with salt water. The use of a resilient plastic material is preferred. This material may be colored, and bright colors such as neon yellow and pink may be used to aid in identification of divers underwater. Logos may be printed on the exterior of the boot.

The illustrated boot included a bottom having a retaining lip and a center hole. It could also be possible to have a solid bottom and side walls with cutouts extending from near the top of the sidewalls of the boot body to flush with the bottom of the tank.

The tank boot body and wheels may be manufactured by extrusion molding of a resilient plastic material (e.g. polyurethane). The exterior surface of the tank boot is smooth. This offers little resistance to water flowing past the tank and avoids snagging of sea weed or other marine life. The holes at the bottom of the boot allow free flow of liquid past the boot, helping reduce drag in the water.

When the tank protected by the boot is removed from the water, liquid will drain from the boot. The salt water could be rinsed off and the boot will allow for ready draining. The boot also provides a stable base for upright storage of the tank.

1. A tank boot comprising:
a hollow boot body having an open end for receiving a compressed gas tank;
a means for retaining said hollow boot body on a tank; and
a pair of wheels on said hollow boot body, said wheels disposed to allow rolling on a surface when said boot is positioned on a tank and said tank is angled with relation to the ground.

2. The tank boot of claim 1 wherein said tank boot is made of plastic.

3. The tank boot of claim 1, wherein said means for retaining said hollow boot body on a tank is a ribbed surface on an interior of the boot body.

4. The tank boot of claim 1, further including a flange extending from a top rim of said hollow boot body.

5. The tank boot of claim 4, wherein said flange extends about the front and sides of the hollow boot body, and said flange has facets.

6. The tank boot of claim 4, wherein said hollow boot body has a boot body bottom, said bottom including an annular lip extending toward a longitudinal center from the bottom of the boot body.

7. A scuba tank boot comprising:
a means for retaining said boot body on a cylindrical tank; and
a means for rolling said boot on a surface when a cylindrical tank has been inserted into said tank boot.

8. The tank boot of claim 7, wherein said means for retaining said boot body is a ribbed surface on an interior of the boot body.

9. The tank boot of claim 7 wherein said scuba tank boot is made of plastic.

10. The tank boot of claim 7, further including a flange extending from a top rim of said hollow boot body.

11. The tank boot of claim 10, wherein said flange extends about the front and sides of the hollow boot body, and said flange has facets.

12. The tank boot of claim 7, wherein said hollow boot body has a boot body bottom, said bottom including an annular lip.
